(19) United States
(12) Patent Application Publication
(10) Pub. No.: US 2023/0142188 A1
(43) Pub. Date: May 11, 2023

(54) PNEUMATIC TIRE

(71) Applicant: Toyo Tire Corporation, Itami-shi (JP)

(72) Inventor: Yuki MITSUNOBU, Itami-shi (JP)

(73) Assignee: Toyo Tire Corporation, Itami-shi (JP)

(21) Appl. No.: 17/965,187

(22) Filed: Oct. 13, 2022

(30) Foreign Application Priority Data
Nov. 5, 2021 (JP) 2021-181391

(51) Int. Cl. B60C 15/06; B60C 15/00

(52) U.S. Cl. CPC B60C 15/0628; B60C 15/0009; B60C 15/0603

(57) ABSTRACT

A pneumatic tire a includes: a pair of beads having a bead core and a bead filler extending from the bead core to an outer side in a tire-radial direction; a pair of sidewalls extending from each of the pair of beads to an outer side in the tire-radial direction; a tread disposed between the pair of sidewalls; a carcass ply bridged between the pair of beads; an internal side reinforcement layer disposed at an inner side in a tire-width direction of the bead filler; and an external side reinforcement layer disposed at an outer side in the tire-width direction of the bead filler, in which the internal side reinforcement layer is disposed more to an inner side in the tire-radial direction than a tire-radial direction outer end of the bead filler, and the external side reinforcement layer has an outside extending part which extends from the bead filler.

This application is based on and claims the benefit of priority from Japanese Patent Application No. 2021-181391, filed on 5 Nov. 2021, the content of which is incorporated herein by reference.

### FIELD

The present invention relates to a pneumatic tire.

### BACKGROUND

Generally, a pneumatic tire has a structure made by coating a backbone structure bridging a carcass ply between a pair of beads arranged at both end inner circumferential parts in the tire width direction, with tread rubber, sidewall rubber, etc. Conventionally, a pneumatic tire has been known in which arranges reinforcement layers that suppress separation from the carcass ply are respectively arranged at both sides in the tire-width direction of a bead filler constituting the beads (for example, refer to Japanese Unexamined Patent Application, Publication No. 2004-130881, etc.).

### SUMMARY

The above-mentioned reinforcement layers arranged at both sides in the tire-width direction of the bead filler in Japanese Unexamined Patent Application, Publication No. 2004-130881 are both shorter than the length in the tire-radial direction of the bead filler. For this reason, upon the tire receiving lateral force, it is assumed that so-called side rigidity resisting this lateral force becomes insufficient, and thus there is room for improvement.

Therefore, the present invention has an object of providing a pneumatic tire capable of an improvement in side rigidity over convention.

A pneumatic tire according to the present invention includes: a pair of beads having a bead core and a bead filler extending from the bead core to an outer side in a tire-radial direction; a pair of sidewalls extending from each of the pair of beads to an outer side in the tire-radial direction; a tread disposed between the pair of sidewalls; a carcass ply bridged between the pair of beads; an internal side reinforcement layer disposed at an inner side in a tire-width direction of the bead filler; and an external side reinforcement layer disposed at an outer side in the tire-width direction of the bead filler, in which the internal side reinforcement layer is disposed more to an inner side in the tire-radial direction than a tire-radial direction outer end of the bead filler, and the external side reinforcement layer has an outside extending part which extends from the tire-radial direction outer end of the bead filler to an outer side in the tire-radial direction.

According to the present invention, it is possible to provide a pneumatic tire capable of an improvement in side rigidity over convention.

### BRIEF DESCRIPTION OF THE DRAWINGS

FIG. 1 is a view showing a half section in a tire-width direction of a pneumatic tire according to an embodiment;

FIG. 2 is a partially enlarged view of FIG. 1; and

FIG. 3 is a view for explaining the configuration of an external side reinforcement layer and internal side reinforcement layer of a tire according to the embodiment.

### DETAILED DESCRIPTION OF THE EMBODIMENTS

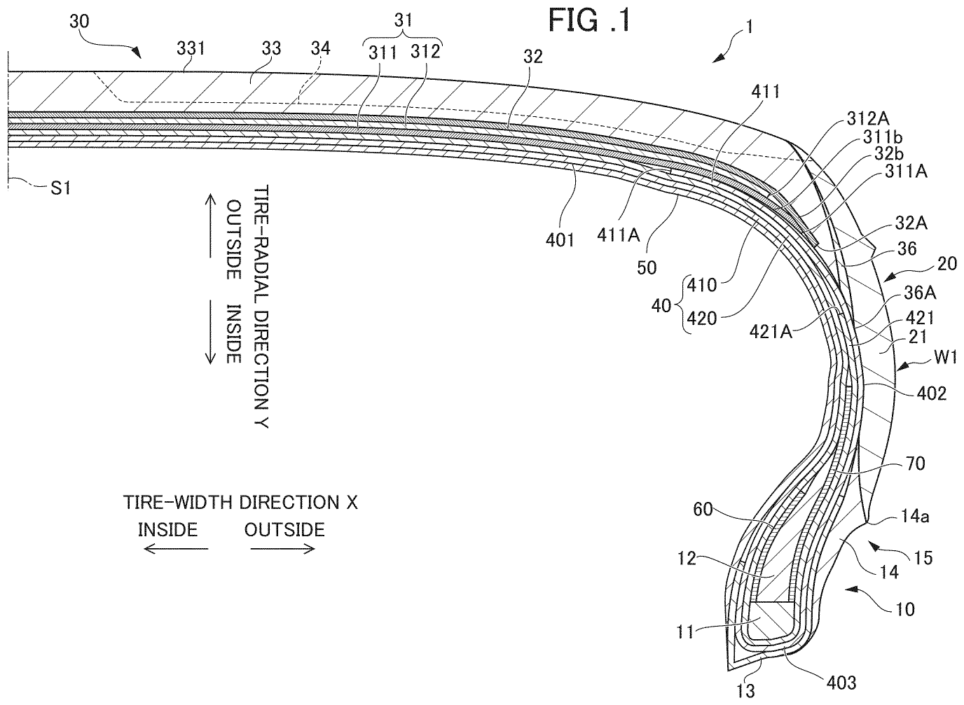

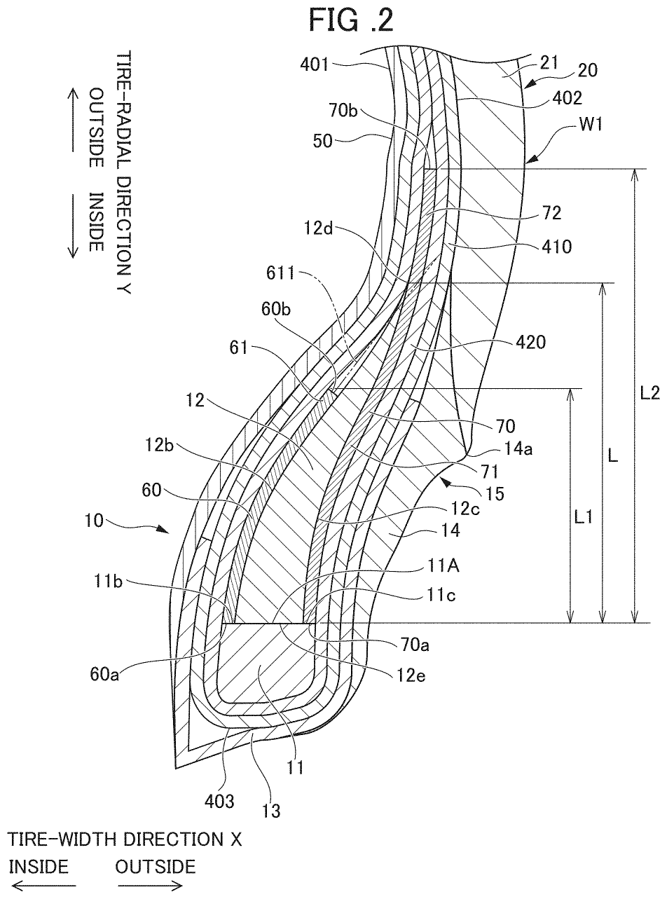

Hereinafter, an embodiment of the present invention will be explained while referencing the drawings. FIG. 1 shows a half section in a tire-width direction of a tire 1, which is a pneumatic tire according to the present embodiment. FIG. 2 is a cross-sectional view enlarging a part of FIG. 1, showing a portion spanning from a bead 10 to a sidewall 20 described later.

The tire 1 according to the present embodiment is a pneumatic tire for passenger vehicles, for example. It should be noted that the tire 1 according to the present embodiment can be adopted for various vehicles such as light trucks, trucks and buses, in addition to passenger vehicles.

The specific structure of the tire 1 is left/right symmetrical in a cross section in the tire-width direction. FIG. 1 is a view showing a half section of the right half of the tire 1, and the left half (not illustrated) is the same structure. In FIG. 1, reference symbol S1 is a tire equatorial plane. The tire equatorial plane S1 is a plane intersecting a tire rotational axis (tire meridian axis), and is positioned at the center in the tire-width direction.

It should be noted that the cross-sectional view of FIG. 1 shows an unloaded state in which the tire 1 is mounted to a standard rim and filled with standard internal pressure. It should be noted that standard rim indicates a rim serving as a standard decided by JATMA corresponding to the tire size. In addition, standard internal pressure is 180 kPa in the case of the tire 1 being for a passenger vehicle, for example.

Herein, tire-width direction is a direction parallel to the tire rotational axis, and is the left/right direction in the paper plane of FIG. 1. In FIG. 1, it is illustrated as the tire-width direction X. The tire-width direction inner side is a direction near the tire equatorial plane S1, and is the left side in the paper plane of FIG. 1. Tire-width direction outer side is a direction distanced from the tire equatorial plane S1, and is the right side in the paper plane of FIG. 1.

In addition, tire-radial direction is a direction perpendicular to the tire rotational axis, and is the vertical direction in FIG. 1. In FIG. 1, it is illustrated as the tire-radial direction Y. A tire-radial direction outer side is a direction distanced from the tire rotational axis, and is an upper side in the paper plane of FIG. 1. Tire-radial direction inner side is a direction approaching the tire rotational axis, and is a lower side in the paper plane of FIG. 1. It should be noted that the same also applies for FIG. 2 described later.

As shown in FIG. 1, the tire 1 includes: a pair of beads 10 provided at both sides in the tire-width direction; a pair of sidewalls 20 extending from each of the pair of beads 10 to the outer side in the tire-radial direction; tread 30 arranged between the pair of sidewalls 20; a carcass ply 40 arranged to bridge between the pair of beads 10; an inner liner 50 arranged on the tire inner cavity side of the carcass ply 40; and an internal side reinforcement layer 60 and external side reinforcement layer 70 provided to the sidewalls 20.

The bead 10 has a bead core 11, bead filler 12 extending from the bead core 11 to the outer side in the tire-radial direction, a chafer 13, and a rim protector 15.

The bead core 11 is an annular member made by bead wires made of rubber-coated metal being wrapped around in the tire-circumferential direction several times. The bead core 11 is a member playing the role of fixing the tire 1 filled with air to the rim. The bead filler 12 takes on a tapered shape as extending from the inner side in the tire-radial direction to the outer side.

As shown in FIG. 2, the bead filler 12 has an inner surface 12b on an inner side in the tire-circumferential direction, an outer surface 12c on an outer side in the tire-circumferential direction, a tire-radial direction outer end 12d which is a tapered-shape tip, and a tire-radial direction inner end 12e. The inner surface 12b and outer surface 12c of the bead filler 12 both gently curve so as to widen to the outer side in the tire-width direction as approaching the outer side in the tire-radial direction, and converge at the tire-radial direction outer end 12d. The tire-radial direction inner end 12e of the bead filler 12 adheres to the tire-radial direction outer end 11A of the bead core 11.

The tire-width direction dimension of the tire-radial direction inner end 12e of the bead filler 12 is smaller than the tire-width direction dimension of the tire-radial direction outer end 11A of the bead core 11. At the inner side in the tire-width direction of the tire-radial direction outer end 11A of the bead core 11, a step part 11b facing the outer side in the tire-radial direction without being covered by the tire-radial direction inner end 12e of the bead filler 12 is formed. At the outer side in the tire-width direction of the tire-radial direction outer end 11A of the bead core 11, a step part 11c facing the outer side in the tire-radial direction without being covered by the tire-radial direction inner end 12e of the bead filler 12 is formed.

The bead filler 12 is provided to raise the rigidity of a circumferential portion of the bead 10, and ensure high maneuverability and stability. The bead filler 12, for example, is configured from rubber having higher hardness than the surrounding rubber members.

The chafer 13 is provided to the inner side in the tire-radial direction of the carcass ply 40 provided around the bead core 11. The rim protector 15 includes rim strip rubber 14. The rim strip rubber 14 is arranged on the outer side in the tire-width direction of the chafer 13 and carcass ply 40. An apex part 14a following the tire-circumferential direction is formed at the outer surface of the rim strip rubber 14. The rim strip rubber 14 contacts with an inner side portion of the rim on which the tire 1 is mounted. The rim protector 15 is continuous in a ring shape in a tire-circumferential direction. The rim protector 15 has a function of protecting the rim from external injury.

The sidewall 20 includes sidewall rubber 21 arranged on the outer side in the tire-width direction of the carcass ply 40. The sidewall rubber 21 configures an outer wall surface of the tire 1. The sidewall rubber 21 is a portion which bends the most upon the tire 1 exhibiting a cushioning action, and usually flexible rubber having fatigue resistance is adopted therein.

The tread 30 includes an endless belt 31 and cap ply 32, and tread rubber 33.

The belt 31 is arranged at an outer side in the tire-radial direction of the carcass ply 40. The cap ply 32 is arranged at an outer side in the tire-radial direction of the belt 31. The belt 31 is a member reinforcing the tread 30. The belt 31 in the embodiment is a two-layer structure including an inner side belt 311 and outer side belt 312. The inner side belt 311 and outer side belt 312 both have a structure in which a plurality of cords such as steel cords is covered with rubber.

In the belt 31 of two-layer structure of the present embodiment, the inner side belt 311 is wider than the outer side belt 312. Therefore, the tire-width direction outer end 311A of the inner side belt 311 is positioned more to the outer side in the tire-width direction than the tire-width direction outer end 312A of the outer side belt 312. By providing the belt 31, the rigidity of the tire 1 is ensured, and the ground contact property of the tread 30 to the road surface improves. It should be noted that the belt 31 is not limited to a two-layer structure, and may have a structure of one layer, or three or more layers.

The cap ply 32 is a member reinforcing the tread 30 together with the belt 31. The cap ply 32, for example, has a structure in which a plurality of organic fiber cords having an insulation property such as polyimide fibers is covered with rubber. A tire-width direction outside end 32A of the cap ply 32 is positioned more to the outer side in the tire-width direction than the tire-width direction outer end 311A of the inner side belt 311. An end part 33b on the outer side in the tire-width direction of the cap ply 32 covers and adheres the end part 311b on the outer side in the tire-width direction of the inner side belt 311. The outer side belt 312 thereby enters a state sandwiched by the cap ply 32 and inner side belt 311. By providing the cap ply 32, it is possible to achieve an improvement in durability and a reduction in road noise during travel.

The tread rubber 33 is arranged on the outer side in the tire-radial direction of the cap ply 32. The tread rubber 33 is a member constituting the tire tread 331 which contacts the road surface during travel. A tread pattern 34 configured by a plurality of grooves, for example, is provided in the tire tread of the tread rubber 33. A high modulus rubber 36 is arranged at the outer side in the tire-width direction of the tread rubber 33. The high modulus rubber 36 is sandwiched between the tread rubber 33 and sidewall rubber 21, and is adhered to the tread rubber 33 and sidewall rubber 21. The high modulus rubber 36 is a belt-like rubber member of comparatively thin thickness, and is configured from rubber of higher modulus (modulus of elasticity of rubber) than the tread rubber 33 and sidewall rubber 21.

The carcass ply 40 configures a ply serving as the backbone of the tire 1. The carcass ply 40 is embedded within the tire 1, in a form passing through the pair of sidewalls 20 and the tire inner wall side of the tread 30 between the pair of beads 10.

The carcass ply 40 includes a plurality of carcass cords (not illustrated) serving as the backbone of the tire 1. The plurality of carcass cords extends in plane along the tire-width direction, for example, and are arranged side by side in the tire-circumferential direction. This carcass cord is configured from an insulative organic fiber cord such as polyester or polyamide, or the like. The plurality of carcass cords is coated by rubber, whereby the carcass ply 40 is configured.

The carcass ply 40 has a ply main body part 401, ply folding part 402, and an elbow-shaped bend 403. The ply main body part 401 is a portion extending from the inner side in the tire-width direction of one bead core 11, through the tread 30 until the inner side in the tire-width direction of the other bead core 11. The ply folding part 402 is a portion which extends to the outer side in the tire-radial direction on the outer side in the tire-width direction of the bead filler 12, by being folded back around the bead core 11 from the tire-radial direction inner end of the ply main body part 401. The elbow-shaped bend 403 is a portion which bends in a U-shape around the bead core 11 from the ply main body part 401, and linked to the ply folding part 402. The ply main body part 401 and ply folding part 402 are continuous via the elbow-shaped bend 403.

The ply main body part 401 is arranged at the inner side in the tire-width direction of the bead core 11 and bead filler 12 on the inner side in the tire-radial direction. The ply folding part 402 is arranged at the outer side in the tire-width direction of the bead core 11 and bead filler 12. The elbow-shaped bend 403 includes an inner most side portion in the tire-radial direction of the carcass ply 40.

The carcass ply 40 of the present embodiment has a two-layer structure in which a first carcass ply 410 and second carcass ply 420 are overlapped. In the ply main body part 401, the first carcass ply 410 is arranged on the tire inner cavity side of the second carcass ply 420.

The second carcass ply 420 of the ply folding part 402 extends from the inner side in the tire-radial direction to the middle of the sidewall 20. The end part 421 on the outer side in the tire-radial direction of the second carcass ply 420 of the ply folding part 402 is superimposed on the second carcass ply 420 of the ply main body part 401 arranged at the sidewall 20. The tire-radial direction outer end 421A of the second carcass ply 420 of the ply folding part 402 is positioned more to the outer side in the tire-radial direction than the tire-radial direction inner end 36A of the high modulus rubber 36.

The first carcass ply 410 of the ply folding part 402 extends to the outer side in the tire-radial direction beyond the tire-radial direction outer end 421A of the second carcass ply 420 from the inner side in the tire-radial direction, and further extends through the sidewall 20 until the end part on the outer side in the tire-width direction of the tread 30. The end part 411 on the outer side in the tire-radial direction of the first carcass ply 410 of the ply folding part 402 is superimposed with a portion spanning from the sidewall 20 to the tread 30 of the second carcass ply 420 of the ply main body part 401. The tire-radial direction outer end 411A of the first carcass ply 410 of the ply folding part 402 is positioned more to the inner side in the tire-width direction than the tire-width direction outer end 312A of the outer side belt 312.

The carcass ply 40 of the present embodiment is a two-layer structure; however, the carcass ply 40 may be one layer, or may be three or more layers. If the carcass ply 40 is configured from ply of a two-layer structure or more layers than this, it is preferable since the tire 1 is sufficiently suppressed from locally deforming in the vicinity of the rim mounting part.

The aforementioned chafer 13 of the bead 10 is provided so as to surround the end part on the inner side in the tire-radial direction of the carcass ply 40 including the elbow-shaped bend 403. In addition, the rim strip rubber 14 is arranged on the outer side in the tire-width direction of the ply folding part 402 of the carcass ply 40 and the chafer 13. The end part on the outer side in the tire-radial direction of the rim strip rubber 14 is covered by the sidewall rubber 21.

The inner liner 50 covers the tire inner surface between the pair of beads 10. Therefore, the inner liner 50 configures the inner wall surface of the tire 1. The inner liner 50 covers the inner surface of the tread 30 and the ply main body part 401 in a region spanning from the tread 30 to the sidewall 20. In addition, the inner liner 50 covers the inner surface of the ply main body part 401 and chafer 13, in a region spanning from the sidewall 20 to the bead 10. The inner liner 50 is configured by air permeation resistant rubber, whereby the air inside the tire inner cavity is prevented from leaking to outside.

Herein, as the rubber adopted in the bead filler 12, rubber having higher hardness than at least the sidewall rubber 21 and inner liner 50 is used. The hardness of the rubber is a value (durometer hardness) measured by a type-A durometer based on JIS K6253 in a 23° C. atmosphere.

For example, when setting the hardness of the sidewall rubber 21 as a reference, the hardness of the bead filler 12 preferably uses rubber of hardness of about 1.2 to 2.3 times the hardness of the sidewall rubber 21. The hardness of the rim strip rubber 14 more preferably uses rubber of hardness on the order of 1 to 1.6 times the hardness of the sidewall rubber 21. By establishing such hardness, it is possible to keep the balance in flexibility as a tire and rigidity in the vicinity of the beads 10.

As shown in FIG. 2, the internal side reinforcement layer 60 is arranged on the inner side in the tire-width direction of the bead filler 12. The internal side reinforcement layer 60 is an annular reinforcement layer along the tire-circumferential direction. The cross-sectional shape in the tire-width direction of the internal side reinforcement layer 60 extends from the inner side to the outer side in the tire-radial direction.

The internal side reinforcement layer 60 adheres to the inner surface 12b of the bead filler 12, in a state in which the tire-radial direction inner end 60a thereof engages with the step part 11_{b} on the inner side of the bead filler 12. Therefore, the tire-radial direction inner end 60a of the internal side reinforcement layer 60 is positioned more to the outer side in the tire-radial direction than the tire-radial direction outer end 11A of the bead core 11. The tire-radial direction length L1 of the internal side reinforcement layer 60 is shorter than the tire-radial direction length L of the bead filler 12. Therefore, the tire-radial direction outer end 60b of the internal side reinforcement layer 60 is positioned more to the inner side in the tire-radial direction than the tire-radial direction outer end 12d of the bead filler 12. In other words, the internal side reinforcement layer 60 is arranged more to the inner side in the tire-radial direction than the tire-radial direction outer end 12d of the bead filler 12. It should be noted that the tire-radial direction inner end 60a of the internal side reinforcement layer 60 may contact with the tire-radial direction outer end 11A of the bead core 11.

In addition, the internal side reinforcement layer 60 adheres to the second carcass ply 420 of the ply main body part 401 of the carcass ply 40. In other words, the internal side reinforcement layer 60 is sandwiched between the bead filler 12 and ply main body part 401, and adheres to both this bead filler 12 and second carcass ply 420 of the ply main body part 401. More specifically, the internal side reinforcement layer 60 may contact with the bead filler 12. In addition, the internal side reinforcement layer 60 may contact with the ply main body part 401. Since the tire-radial direction inner end 60a and tire-radial direction outer end 60b of the internal side reinforcement layer 60 are thereby protected by the carcass ply 40, the inner liner 50 is avoided from receiving external injury by the internal side reinforcement layer 60.

Herein, it is good for the tire-radial direction outer end 12d of the bead filler 12 and tire-radial direction outer end 60b of the internal side reinforcement layer 60 not to have matching positions in the tire-radial direction X for manufacturing; however, the tire-radial direction length of the internal side reinforcement layer 60 is preferably as long as possible from the aspect of a rigidity improvement. From this viewpoint, in the present embodiment, the tire-radial direction length L1 of the internal side reinforcement layer 60 is preferably at least 60% and no more than 90% of the tire-radial direction length L of the bead filler 12, and more preferably at least 70% and no more than 90%.

As shown in FIG. 2, the external side reinforcement layer 70 is arranged at the outer side in the tire-width direction of the bead filler 12. The external side reinforcement layer 70 is an annular reinforcement layer along the tire-circumferential direction. The cross-sectional shape in the tire-width direction of the external side reinforcement layer 70 extends from the inner side to the outer side in the tire-radial direction.

The external side reinforcement layer 70 adheres to the outer surface 12c of the bead filler 12, in a state in which the tire-radial direction inner end 70a thereof engages with the step part 11c on the outer side of the bead filler 12. Therefore, the tire-radial direction inner end 70a of the external side reinforcement layer 70 is positioned more to the outer side in the tire-radial direction than the tire-radial direction outer end 11A of the bead core 11. It should be noted that the tire-radial direction inner end 70a of the external side reinforcement layer 70 may contact with the tire-radial direction outer end 11A of the bead core 11.

The tire-radial direction length L2 of the external side reinforcement layer 70 is longer than the tire-radial direction length L of the bead filler 12. The external side reinforcement layer 70 has an inside extending part 71 on the inner side in the tire-radial direction adhering to the outer surface 12c of the bead filler 12, and an outside extending part 72 extending more to the outer side in the tire-radial direction than the tire-radial direction outer end 12d of the bead filler 12. The leading end of the outside extending part 72, i.e. tire-radial direction outer end 70b of the external side reinforcement layer 70, is at substantially the same position as the widest position W1 of the tire 1 in the tire-radial direction, or between the widest position W1 of the tire 1 and the tire-radial direction outer end 12d of the bead filler 12.

The entirety of the external side reinforcement layer 70, i.e. inside extending part 71 and outside extending part 72, all adhere to the second carcass ply 420 of the ply folding part 402 of the carcass ply 40. Herein, the inside extending part 71 is sandwiched between the bead filler 12 and ply folding part 402, and adheres to both this bead filler 12 and second carcass ply 420 of the ply folding part 402. In other words, the inside extending part 71, which is part of the external side reinforcement layer 70, is sandwiched between the bead filler 12 and ply folding part 402. More specifically, the external side reinforcement layer 70 may contact with the bead filler 12. In addition, the external side reinforcement layer 70 may contact with the second carcass ply 420 of the ply folding part 402.

On the other hand, the outside extending part 72 which is a portion extending to the outer side in the tire-radial direction beyond the tire-radial direction outer end 12d of the bead filler 12 is sandwiched between the second carcass ply 420 on the side of the ply main body part 401 and the second carcass ply 420 on the side of the ply folding part 402. In other words, the outside extending part 72 is sandwiched between the ply main body part 401 and ply folding part 402. In other words, the outside extending part 72 is disposed at an outer side in the tire-width direction of the ply main body part 401. The outside extending part 72 adheres to both the second carcass ply 420 on the side of the ply main body part 401 and the second carcass ply 420 on the side of the ply folding part 402. The tire-radial direction outer end 70b of the external side reinforcement layer 70 is thereby suppressed from forming a step at the outer surface of the sidewall 20, and thus a favorable appearance characteristic is retained. In addition, since the tire-radial direction outer end 70b of the external side reinforcement layer 70 is protected by the carcass ply 40, the inner liner 50 is avoided from receiving external injury by the external side reinforcement layer 70.

In the present embodiment, the tire-radial direction length L2 of the external side reinforcement layer 70 is preferably at least 110% and no more than 170% the tire-radial direction length L of the bead filler 12, and is more preferably at least 120% and no more than 160%.

In the present embodiment, the tire-radial direction outer end 60b of the inside inner reinforcement layer 60 is positioned more to the inner side in the tire-radial direction than the tire-radial direction outer end 12d of the bead filler 12. In addition, the tire-radial direction outer end 70b of the external side reinforcement layer 70 is positioned more to the outer side in the tire-radial direction than the tire-radial direction outer end 12d of the bead filler 12. In this way, by the tire-radial direction outer end of each of the internal side reinforcement layer 60 and external side reinforcement layer 70 shifting to the tire-radial direction, without aligning with the tire-radial direction outer end of the bead filler 12, stress concentration hardly occurs. As a result thereof, an improvement in durability is achieved.

As shown in FIG. 2, the outside end part 61 in the tire-radial direction of the aforementioned internal side reinforcement layer 60 points to the external side reinforcement layer 70. A virtual extension line 611 extending in a pointing direction of this outside end part 61 from the outside end part 61 in the tire-radial direction of the internal side reinforcement layer 60 intersects the external side reinforcement layer 70.

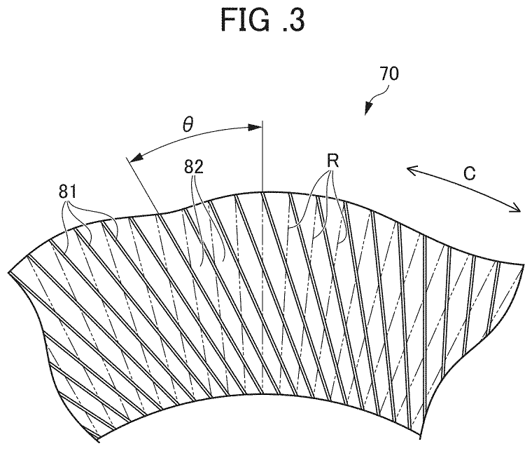

In the internal side reinforcement layer 60 and external side reinforcement layer 70 in the present embodiment, the metal fiber cord layer containing metal fibers is favorably used. FIG. 3 is a view showing a part of the external side reinforcement layer 70 from a metal fiber cord layer, and is a virtual diagram when viewing the external side reinforcement layer 70 arranged within the tire 1 from the outer side in the tire-width direction towards the inner side in the tire-width direction. It should be noted that the internal side reinforcement layer 60 is also configured by a metal fiber cord layer similarly to the external side reinforcement layer 70. Therefore, herein, the structures for both the internal side reinforcement layer 60 and external side reinforcement layer 70 are described later on behalf of the external side reinforcement layer 70, according to FIG. 3.

The external side reinforcement layer 70 is configured to include a plurality of metal cords 81 formed by intertwining a plurality of metal fibers, and topping rubber 82 integrated by coating the plurality of metal cords 81.

The plurality of metal cords 81 are arranged with an interval in the tire-circumferential direction C in a sloped state extending to slope relative to the radial direction R of the tire 1. The interval between the plurality of metal cords 81 aligned in the tire-circumferential direction C widens as approaching the outer side in the tire-radial direction.

The angle θ formed by the radial direction R of the tire 1 and the extending direction of the metal cord 81 of the external side reinforcement layer 70 is preferably at least 10° and no more than 40°. It should be noted that, in the present embodiment, the ply cord constituting the carcass ply 40 is arranged radially (radial direction R) from the center of the tire 1. Consequently, in the present embodiment, the angle θ formed by the extending direction of the ply cord of the carcass ply 40 and the extending angle of the metal cords 81 of each of the internal side reinforcement layer 60 and external side reinforcement layer 70 is at least 10° and no more than 40°. The sloping direction of the metal cords 81 of the internal side reinforcement layer 60 may be the opposite direction to the sloping direction of the metal cords 81 of the external side reinforcement layer 70.

In this way, by having the ply cords of the carcass ply 40 and the metal cords 81 of each of the internal side reinforcement layer 60 and external side reinforcement layer 70 intersect in a side view, it is possible to raise the rigidity of the portion at which the internal side reinforcement layer 60 and external side reinforcement layer 70 overlap with the carcass ply 40.

As the metal constituting the metal cord 81, a metal cord material having flexibility while being high strength, and having high fatigue resistance is preferable, and steel cord is more preferably used, for example. In the case of steel cord, for example, cord made by intertwining several to several tens of wires consisting of high carbon steel on the order of φ0.1 to φ0.5 mm, and conducting plating to raise the adhesive property with the rubber as necessary can be used. As the metal cords 81 of the present embodiment, those having an outside diameter (cord diameter) of at least 0.5 mm and no more than 1.2 mm are preferably used, for example.

It should be noted that the internal side reinforcement layer 60 and external side reinforcement layer 70 may be reinforcement layers in which a plurality of organic fiber cords having an insulation property such as polyamide fibers are covered with rubber, similarly to the cap ply 32, for example.

According to the tire 1 of the present embodiment, upon the tire 1 receiving lateral force during cornering or the like, the external side reinforcement layer 70 strongly resists this lateral force, and exerts sufficient side rigidity. In addition, upon receiving lateral force, the internal side reinforcement layer 60 effectively suppresses deflection of the bead filler 12, whereby sufficient side rigidity is exhibited. Therefore, the side rigidity drastically rises by the internal side reinforcement layer 60 and external side reinforcement layer 70, a result of which an improvement in cornering performance is possible.

As in the present embodiment, when the tire-radial direction length L1 of the internal side reinforcement layer 60 is at least 60% and no more than 90% of the tire-radial direction length L of the bead filler 12, it is particularly preferable in the internal side reinforcement layer 60 suppressing deflection of the bead filler 12.

Herein, three types of analysis models of tires including the same configurations as the present embodiment but with different tire-radial direction lengths L1 of the internal side reinforcement layer 60 relative to the tire-radial direction length L of the bead filler 12 were prepared, and the characteristics related to the rigidity of these tires were measured by simulation. In addition, for comparison, a tire having only the external side reinforcement layer 70 without the internal side reinforcement layer 60 was prepared as a model 0, and the characteristics related to rigidity were measured by simulation in the same way. The results thereof are shown in Table 1.

As shown in Table 1, for models 1 to 3 of the tire, the proportion L1/L (%) of the tire-radial direction length L1 of the internal side reinforcement layer 60 relative to the tire-radial direction length L of the bead filler 12 were respectively 50%, 70% and 80%. The characteristics measured by simulation were measured, as rigidity values, the three types of “front/rear rigidity”, which is the resistance to load received from a front/rear direction during acceleration and during deceleration, “lateral rigidity” against the load from a lateral direction, and “vertical rigidity” against vertical load applied from above to below. In Table 1, the rigidity improvement rate indicating how much the rigidity of each of the models 1 to 3 improves relative to model 0 without the internal side reinforcement layer 60 is written jointly with the rigidity value.

It should be noted that the tires of the respective measured models correspond to rims of 19×10.0J (19 inch rim diameter, 10 inch rim width, flange shape: J), and the internal pressure in a state mounted to this rim was measured at 220 kpa. In addition, the vertical load on the tire was set as 680 kg, the front/rear load was set as 204 kg, and the horizontal load was set as 204 kg, and each load was applied to the tire.

TABLE 1

| | | Model 1 (50%) | | Model 2 (70%) | | Model 3 (80%) | |
|---|---|---|---|---|---|---|---|
| | | | Rigidity | | Rigidity | | Rigidity |
| | Rigidity value | Rigidity | improvement | Rigidity | improvement | Rigidity | improvement |
| | of model 0 | value | rate | value | rate | value | rate |
| front/rear | 582.5 | 600.5 | 3.10% | 606.6 | 4.14% | 602.0 | 3.35% |
| rigidity | | | | | | | |
| lateral | 338.0 | 340.9 | 0.85% | 344.9 | 2.02% | 341.4 | 0.99% |
| rigidity | | | | | | | |
| Vertical | 380.5 | 382.5 | 0.51% | 381.6 | 0.28% | 382.0 | 0.39% |
| rigidity | | | | | | | |

According to Table 1, all the tires having the internal side reinforcement layer 60 had improved rigidity, and the rigidity improvement effect of the internal side reinforcement layer 60 was confirmed. However, model 1 had lower lateral rigidity and higher vertical rigidity than model 2 and model 3. This concerns a decline in ride quality due to model 1 having relatively low side rigidity against lateral force, and high vertical rigidity. Therefore, the tire-radial direction length L1 of the internal side reinforcement layer 60 is preferably at least 50% relative to the tire-radial direction length L of the bead filler 12. In addition, if the tire-radial direction length L1 of the internal side reinforcement layer 60 is similar to the tire-radial direction length L of the bead filler 12, the tire-radial direction outer ends of both will be aligned; however, this leads to stress concentration on this portion, and there is concern over causing a decline in durability. For these reasons, the proportion L1/L of the tire-radial direction length L1 of the internal side reinforcement layer 60 relative to the tire-radial direction length L of the bead filler 12 is considered preferably at least 60% and no more than 90%.

According to the tire 1 of the present embodiment, the following effects are exerted.

(1) The tire 1 according to the present embodiment includes: a pair of beads 10 having a bead core 11 and a bead filler 12 extending from the bead core 11 to an outer side in the tire-radial direction; a pair of sidewalls 20 extending from each of the pair of beads 10 to the outer side in the tire radial direction; tread 30 arranged between the pair of sidewalls 20; the carcass ply 40 bridging between the pair of beads 10; the internal side reinforcement layer 60 arranged at the inner side in the tire-width direction of the bead filler 12; and the external side reinforcement layer 70 arranged at the outer side in the tire-width direction of the bead filler 12, in which the internal side reinforcement layer 60 is arranged more to the inner side in the tire-radial direction than the tire-radial direction outer end of the bead filler 12, and the external side reinforcement layer 70 has an outside extending part 72 extending from the tire-radial direction outer end of the bead filler 12 to the outer side in the tire-radial direction.

It thereby becomes possible to achieve an improvement in side rigidity over convention, a result of which an improvement in cornering performance becomes possible.

(2) In the tire 1 according to the present embodiment, it is preferable for the carcass ply 40 to have: the ply main body part 401 extending between the tread 30 and an inner side in the tire-width direction of the bead 10; and the ply folding part 402 extending to an outer side in the tire-radial direction at an outer side in the tire-width direction of the bead filler 12, by being folded back around the bead core 11 from the tire-radial direction inner end of the ply main body part 401, and for the internal side reinforcement layer 60 to be sandwiched between the bead filler 12 and ply main body part 401, and a part of the external side reinforcement layer 70 to be sandwiched between the bead filler 12 and ply folding part 402.

It is thereby possible to obtain a drastic improvement effect in side rigidity by cooperation of the carcass ply 40 with the internal side reinforcement layer 60 and external side reinforcement layer 70. In addition, during manufacture of the tire 1, since it is possible to bring the internal side reinforcement layer 60 and external side reinforcement layer 70 into contact with the bead filler 12, positioning of the internal side reinforcement layer 60 and external side reinforcement layer 70 is easy to do, and manufacturing is facilitated.

(3) In the tire 1 according to the present embodiment, the tire-radial direction inner end 60a of the internal side reinforcement layer 60 and the tire-radial direction inner end 70a of the external side reinforcement layer 70 are both preferably positioned more to the outer side in the tire-radial direction than the tire-radial direction outer end of the bead core 11.

It thereby becomes possible to sufficiently exhibit a deflection suppression effect of the bead filler 12 by each of the internal side reinforcement layer 60 and the external side reinforcement layer 70 without being inhibited by the bead core 11, and thus possible to precisely improve the side rigidity.

(4) In the tire 1 according to the present embodiment, the outside extending part 72 of the external side reinforcement layer 70 is preferably sandwiched between the ply main body part 401 and ply folding part 402.

It is thereby possible to obtain a drastic improvement effect in the side rigidity by cooperation between the carcass ply 40 and the outside extending part 72 of the external side reinforcement layer 70. In addition, the outside extending part 72 of the external side reinforcement layer 70 is protected by the carcass ply 40, and negative influences on the tire outer surface and tire inner surface is avoided by the outside extending part 72.

(5) In the tire 1 according to the present embodiment, the tire-radial direction length L1 of the internal side reinforcement layer 60 is preferably at least 60% and no more than 90% of the tire-radial direction length L of the bead filler 12.

It is thereby possible to precisely obtain the deflection suppression effect of the bead filler 12 by the internal side reinforcement layer 60.

(6) In the tire 1 according to the present embodiment, the outside end part 61 in the tire-radial direction of the internal side reinforcement layer 60 points to the external side reinforcement layer 70, and the virtual extension line 611 extending in the pointing direction of this outside end part 61 preferably intersects the external side reinforcement layer 70.

It is thereby possible to more effectively suppress deformation in which the external side reinforcement layer 70 bends to the inner side in the tire-width direction by the internal side reinforcement layer 60, upon receiving strong lateral force, whereby an even greater improvement in side rigidity becomes possible.

It should be noted that the present invention is not limited to the above-mentioned embodiment, and even if performing modifications, improvements, etc. in a scope which can achieve the object of the present invention, it will be encompassed in the scope of the present invention.

For example, the internal side reinforcement layer 60 and external side reinforcement layer 70 may not be adhered to the bead filler 12, and a separate rubber layer may be interposed between each of the internal side reinforcement layer 60 and external side reinforcement layer 70, and the bead filler 12.

So long as the outside extending part 72 of the external side reinforcement layer 70 is extending more to the outer side in the tire-radial direction than the bead filler 12, the length thereof is not limited, and may extend from the sidewall 20 over the tread 30, instead of the ply folding part 402 of the carcass ply 40, for example.

What is claimed is:

1. A pneumatic tire, comprising:
a pair of beads having a bead core and a bead filler extending from the bead core to an outer side in a tire-radial direction;
a pair of sidewalls extending from each of the pair of beads to an outer side in the tire-radial direction;
a tread disposed between the pair of sidewalls;
a carcass ply bridged between the pair of beads;
an internal side reinforcement layer disposed at an inner side in a tire-width direction of the bead filler; and
an external side reinforcement layer disposed at an outer side in the tire-width direction of the bead filler,
wherein the internal side reinforcement layer is disposed more to an inner side in the tire-radial direction than a tire-radial direction outer end of the bead filler, and
wherein the external side reinforcement layer has an outside extending part which extends from the tire-radial direction outer end of the bead filler to an outer side in the tire-radial direction.

2. The pneumatic tire according to claim 1, wherein the carcass ply comprises:
a ply main body part extending between the tread and an inner side in the tire-width direction of the bead, and
a ply folding part which extends to an outer side in the tire-radial direction at an outer side in the tire-width direction of the bead filler, by being folded back around the bead core from a tire-radial direction inner end of the ply main body part,
wherein the internal side reinforcement layer is sandwiched between the bead filler and the ply main body part, and
wherein a part of the external side reinforcement layer is sandwiched between the bead filler and the ply folding part.

3. The pneumatic tire according to claim 1, wherein a tire-radial direction inner end of the internal side reinforcement layer and a tire-radial direction inner end of the external side reinforcement layer are both located more to an outer side in the tire-radial direction than the tire-radial direction outer end of the bead core.

4. The pneumatic tire according to claim 2, wherein the outside extending part is sandwiched between the ply main body part and the ply folding part.

5. The pneumatic tire according to claim 2, wherein the outside extending part is disposed at an outer side in the tire-width direction of the ply main body part.

6. The pneumatic tire according to claim 1, wherein a tire-radial direction length of the internal side reinforcement layer is at least 60% and no more than 90% of a tire-radial direction length of the bead filler.

7. The pneumatic tire according to claim 1, wherein a tire-radial direction length of the external side reinforcement layer is at least 110% and no more than 170% of a tire-radial direction length of the bead filler.

8. The pneumatic tire according to claim 1, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

9. The pneumatic tire according to claim 2, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

10. The pneumatic tire according to claim 3, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

11. The pneumatic tire according to claim 4, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

12. The pneumatic tire according to claim 5, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

13. The pneumatic tire according to claim 6, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.

14. The pneumatic tire according to claim 7, wherein an outside end part in a tire-radial direction of the internal side reinforcement layer points to the external side reinforcement layer, and a virtual extension line extending in a pointing direction of the outside end part from the outside end part in a tire-radial direction of the internal side reinforcement layer intersects the external side reinforcement layer.
